(19) United States
(12) Patent Application Publication
(10) Pub. No.: US 2018/0158360 A1
(43) Pub. Date: Jun. 7, 2018

(54) Life/Business Coaching Process-Life First

(71) Applicant: Walter Stephen Cook, Baraboo, WI (US)

(72) Inventor: Walter Stephen Cook, Baraboo, WI (US)

(21) Appl. No.: 15/369,850

(22) Filed: Dec. 5, 2016

(51) Int. Cl. G09B 19/00; G06Q 10/10

(52) U.S. Cl. CPC G09B 19/00; G06Q 10/1093

(57) ABSTRACT

A business coaching process for life and business management that enables people to live and experience life first rather than letting money and business shape their lives.

### FIELD OF INVENTION

This invention generally relates to a business coaching process for life and business management, with particular emphasis on living and experiencing life first, and then building a business according to one's lifestyle.

### BACKGROUND

Most life and business coaching programs focus on building a better business income in order to live a better life. The belief is that if more money can be earned then someone will automatically have more time or better life. The problem with these programs is that one actually trades their life away in pursuit of success, which is the very thing they hope to achieve. Lifeonaire takes a different approach. If living and experiencing a full life is what one desires, this process puts emphasis on pursuing life, not money in hopes that it will give us life. This process has the students focussed on living and experiencing life first, and then building a business to suit their lifestyle, not the other way around.

### BRIEF SUMMARY OF THE INVENTION

The present invention takes the students through a process in which they develop a life vision, one which focuses on living and experiencing the life that they desire to have. It takes a number of exercises to cut through the clutter and get them to the point where they can come up with a life vision, exclusive of their business or career. Once they have completed their life vision this invention can have them fill out a calendar or day planner as if they were currently living and experiencing the life vision that they just came up with. This allows them to see that the only way they can experience all of the things that they want to in life is not to work as much as they have been. The remaining hours on their day planner is the time that they have to build their business in and earn an income. This process then has them go through and apply a cost to living their life vision. This leaves them with the building blocks for starting a business or career. They know how much money they need to make and how much time they have to work in order to make it.

### BRIEF DESCRIPTION OF THE DRAWINGS

FIG. 1 shows a process which takes the students through a number of exercises in which they end up with a written vision of how they would like for their life to look, exclusive of their work. This process then has them apply the elements of their vision to calendar as if they were experiencing the life that they desire to live, they will have used up much of the time available to them every week and they will not have filled in work or business or career yet. They then need to determine how many hours are left to actually work in order for them to live and experience the life they desire to live. The present invention then uses this as one of the building blocks for designing a business that serves the life they desire to live.

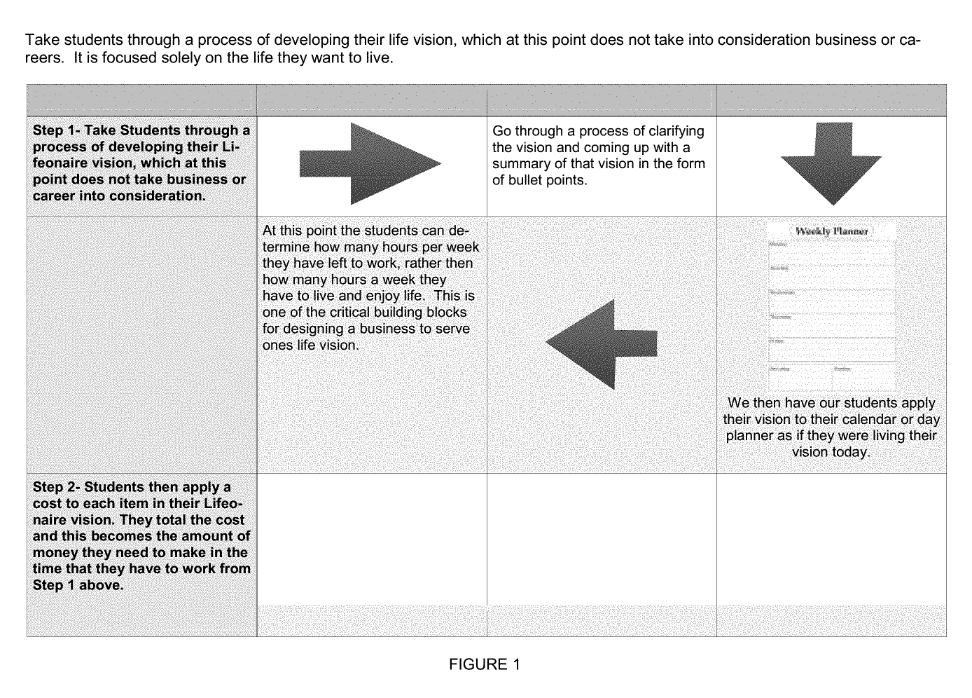

A critical step flows from the concept in FIG. 1 which is the application of a cost to your Lifeonaire Vision. This process has the students apply a cost to each element of their Lifeonaire Vision. They can calculate this monthly or annually. This is how much money you need to earn in the time left from FIG. 1 to live and experience the life that one desires. It is the second of the building blocks in designing the business that one needs to experience their Lifeonaire vision.

### DETAILED DESCRIPTION AND BEST MODE OF IMPLEMENTATION

This business process teaches people how to live and experience abundant lives. Most Americans find themselves working so much that they do not enjoy life. The reason is that they are pursuing money in hopes that it will give life back to them. This process teaches them to pursue life, and to build a business or career that will help them to live and experience the life they desire. The present invention puts Life first. This invention takes the students through a process of helping them to develop a life vision, one that excludes their careers and money. They are focussed on living life. The process for developing the vision includes multiple steps and exercises. Once a student has developed their vision, this invention then has them fill out a calendar or day planner as if they were experiencing that life right now. This is an eye opener for them at this point they clearly realize they cannot live the life that they desire to live if they are doing what they are today. Something has to change. They realize they must earn enough income in a shorter period of time in order to have the time necessary to experience life. This business invention does this by teaching them that the way they are pursuing life is by trading their life away. This process gets them to come to the conclusion that they need to stop trading their life and future away and to start focussing on protecting it and living it now. The calendar exercise is unique from any other program out there. They all encourage people to build a business, pursue a career, or focus on life without tying the two together and putting life first.

After the invention has established how much time it has to work, the process then focuses on how much money needs to be made. This leads to a completely different question than what anyone else asks. What does my business or career need to look like in order for me to make so many dollars in so much time? If these are the building blocks for a business, the user will come up with very different results.

The embodiments of the invention in which an exclusive property or privilege is claimed are as follows:

1. A business process that teaches people how to live and make the best of their lives.

2. The business process according to claim 1 wherein such process puts one's life at the forefront.

3. A business process according to claim 1 wherein such process makes use of a unique calendar.

4. The calendar according to claim 3 wherein such calendar allows users to live their lives abundantly.
